(19) United States
(12) Patent Application Publication
(10) Pub. No.: US 2008/0190378 A1
(43) Pub. Date: Aug. 14, 2008

(54) Hand-Held Transmitter for Animal Controller

(76) Inventor: Lance Tracy, Oak Ridge, TN (US)

Correspondence Address: PITTS AND BRITTIAN P C, P O BOX 51295, KNOXVILLE, TN, 37950-1295, US

(21) Appl. No.: 11/672,951

(22) Filed: Feb. 8, 2007

(51) Int. Cl. A01K 15/02

(52) U.S. Cl. 119/720

(57) ABSTRACT

A transmitter for a signal to be directed to a receiver borne on an animal which is being trained or otherwise desirably under the control of a handler. The transmitter of this invention, in a preferred embodiment, takes on the form of a pistol butt grip geometry having butt grip panels affixed to the opposite sides of the pistol butt grip. Each panel is formed of a luminescent material, hence it glows in the dark. Multifaceted surfaces of the butt grip panel are exposed about substantially all of the outwardly exposed side, front, rear and end surfaces of the butt grip panel, making it readily detectable in a dark environment.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to hand-held devices employed to convey a radio frequency or like training or obedience signal to a receiver mounted on an animal, especially a dog, and more especially a dog of the hunting hound breed.

### BACKGROUND OF INVENTION

It is known in the art to apply to a dog a receiver for a signal, such as a radio frequency signal and to provide a transmitter of such signal to be held in the hand of a trainer or a hunter or other person having a reason to transmit a training or obedience signal to the dog. Hand-held transmitters, however, are prone to being dropped. Location of the dropped transmitter is especially difficult when the transmitter is dropped at night and can not be readily identified in the dark. Commonly such transmitters of the prior art are of a dull or dark color for esthetic purposes, such as minimization of visible physical scratches, dents, or the like. The present invention is particularly useful in the instance where a hand-held transmitter is being employed with a hunting dog of the hound breed, such as hounds used in hunting animals that are active at night in the dark.

Loss of a transmitter by a handler of the dog can result in the lack of control over the dog and even uncontrolled roaming of the dog or the dog becoming lost in the woods.

### SUMMARY OF INVENTION

In accordance with one aspect of the present invention, there is provided a hand-held transmitter, which, in a preferred embodiment, takes on the form of a pistol butt grip geometry having butt grip panels affixed to the opposite sides of the pistol butt grip. Each panel is formed of a luminescent material; hence it glows in the dark. Multifaceted surfaces of the butt grip panel are exposed about substantially all of the outwardly exposed sides and the front, rear and end surfaces of the butt grip panel, making it readily detectable in a dark environment.

In a preferred embodiment, the outer exposed surface of each butt grip panel is embossed to provide a multiplicity of closely-spaced multifaceted pyramidal-like projections which mutually cooperate to emit light beams at multiple angles away from the outer exposed surface of the panel. In the absence of luminescence, these multifaceted embossments function to receive and reflect a light beam from a battery-powered light, for example.

### BRIEF DESCRIPTION OF THE DRAWINGS

FIG. 1 is a perspective view of a hand-held transmitter having a pistol butt grip geometry and including a butt grip panel of the present invention;

FIG. 2 is a side plan view of a butt grip panel of the present invention adapted to be mounted onto a first side of the pistol butt grip of FIG. 1;

FIG. 3 is a side plan view of a butt grip panel of the present invention adapted to be mounted onto a second and opposite side of the pistol butt grip of FIG. 1;

FIG. 4 is a side plan view of a transmitter as depicted in FIG. 1 having a pistol butt grip geometry and including a butt grip panel of FIG. 2 mounted on a first side thereof;

FIG. 5 is a side plan view of a transmitter as depicted in FIG. 1 having a pistol butt geometry and including a butt grip panel of FIG. 3 mounted on a second side thereof;

FIG. 6 is a front elevation view of the transmitter depicted in FIG. 1 and including grip panels as depicted in FIGS. 2 and 3 mounted on opposite sides thereof;

FIG. 7 is a rear elevation view of the transmitter depicted in FIG. 6;

FIG. 8 is a top view of the transmitter depicted in FIG. 1;

FIG. 9 is a bottom view of the transmitter depicted in FIG. 1;

FIG. 10 is an enlarged view of a portion of the outer surface of the butt grip panel depicted in FIG. 2; and,

FIG. 11 is a sectional view of the panel depicted I FIG. 2, taken generally along the line 11-11 of FIG. 2.

### DETAILED DESCRIPTION OF INVENTION

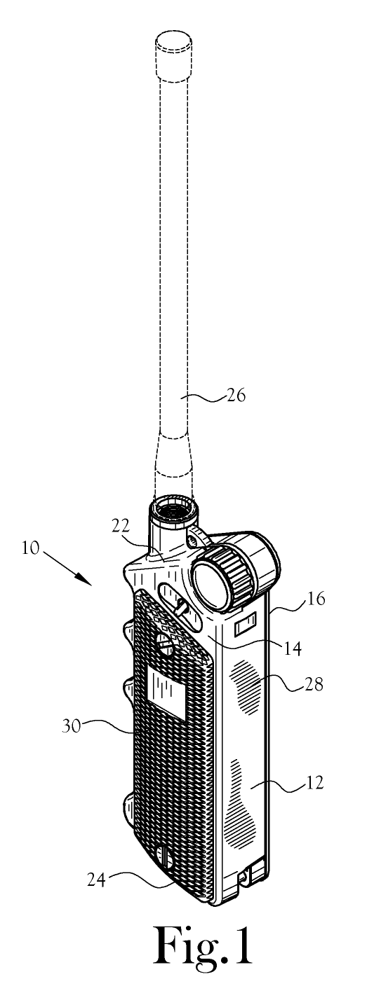

Referring initially to FIG. 1, one embodiment of the present invention includes a transmitter 10 of the pistol butt grip geometry variety. Generally, the transmitter includes a housing 12 having first and second opposite sides 14 and 16, respectively, front and rear sides 18 and 20, respectively and a top end 22 and a bottom end 24. This housing serves to house the electronic and other components of the transmitter as are well known in the art. Further, the housing serves to mount thereon an antenna 26 useful in broadcasting a signal such as a radio frequency signal to a remote receiver, such as a receiver mounted on a collar worn by a dog, all as is well known in the art.

Referring to the several Figures, in accordance with one aspect of the present invention, there is provided a first generally rectangular and relatively thin butt grip panel 30 affixed to a first side 14 of the pistol butt grip portion of the housing. Preferably, this grip panel is removably affixed to the butt grip as by screws 32. In like manner, in the present invention, there is provided a second grip panel 36 removably affixed to the second and opposite, side 16 of the pistol butt grip of the transmitter housing.

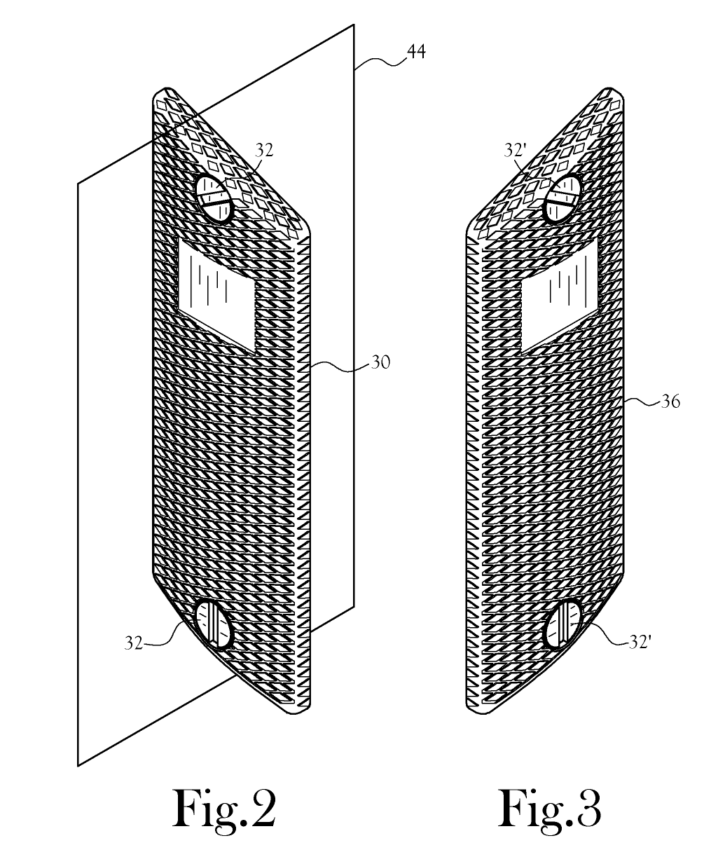

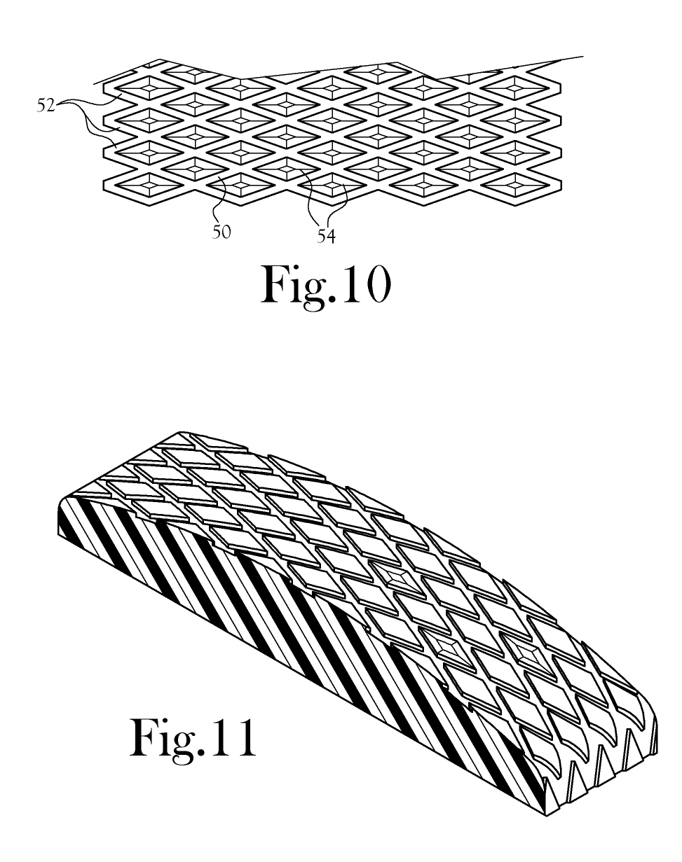

With further reference to the several Figures and employing primed numerals for like components of the present invention, each of the butt grip panels 28 and 36 of the present invention includes a respective reverse side 38, 38′ which are exposed inwardly toward and overlie respective ones of the first and second sides 14 and 16 of the pistol grip portion 28 of the transmitter housing. In one embodiment, this reverse side of each butt grip panel is substantially flat and contiguously overlies its respective one of the first or second side of the pistol butt grip of the receiver housing. On the contrary, each the exposed surfaces of the front sides 40,40′ of the butt grip panel is of a curved geometry, each butt grip panel sloping from a maximum thickness at a longitudinal centerplane 44 (FIG. 2) thereof to minimum thicknesses at the respective side edges 46, 46′ and 48,48′ thereof which are most distant from the longitudinal centerplane, thereby defining an outwardly curved surface which is of substantially equal cross-sectional geometry from the top end 22 to the bottom end 24 of the panel. As depicted in the several Figures, and specifically in FIGS. 10 and 11, this curved outer surface is provided with intersecting substantially parallel linear depressions 52 which are spaced apart by about 0.08 inch and which extend angularly between the opposite sides of the panel. Preferably each linear depression is of a generally “V” shaped cross section (FIG. 11), and of a depth of about 0.01 inch. thereby causing the intersecting rows of depressions to generate a multiplicity of multifaceted pyramidal shaped reflective and/or refractive embossments 54 over substantially uniformly the entire outer surface of the panel. In a preferred embodiment, these embossments extend about the first and second side edges, the top and the bottom of each butt grip panel. Accordingly, irrespective of the orientation of a dropped transmitter, its luminescent glow may be readily detectable.

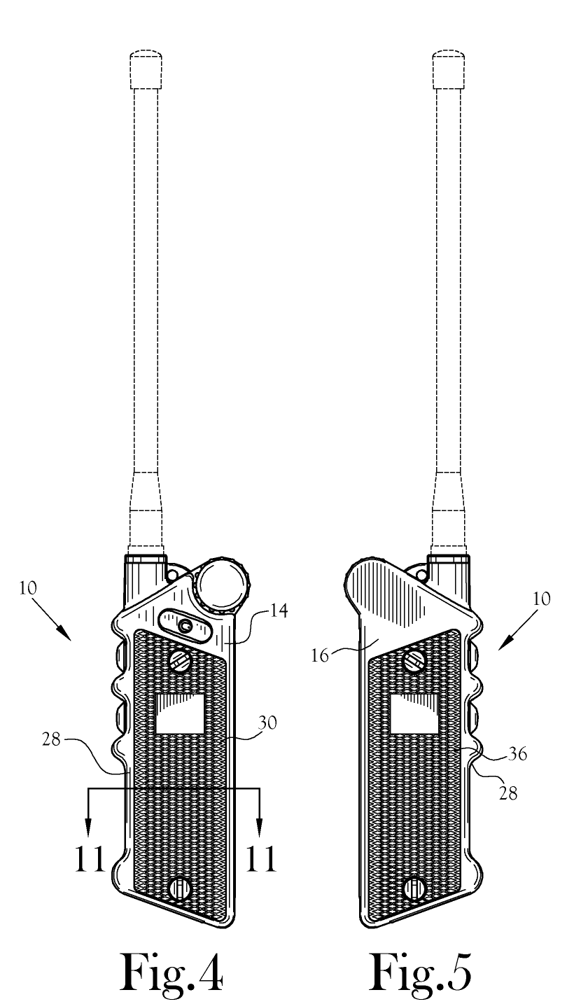

As depicted in FIGS. 4 and 5, a butt grip panel of the present invention is affixed to each of the opposite sides of the pistol grip butt of the transmitter. Accordingly, these embossed panels also enhance the user's ability to securely grip the transmitter in their hand.

In accordance with one aspect of the present invention, each panel is formed of a luminescent material so that each panel glows in the dark. Therefore, should the transmitter be dropped to the ground during a night excursion into a wooded area, for example, the present invention provides multifaceted apparent sources of luminescent rays 56 emanating from each of the butt grip panels affixed to the opposite sides of the pistol butt grip of the transmitter. Moreover, should the luminescence of the material of which the panel is constructed diminish or entirely expire, there remains a multiplicity of multifaceted reflective surfaces which enhance the likelihood that a battery-powered light beam 58 (See dark line of FIG. 11) moved onto or past a dropped transmitter will readily reflect from an exposed panel of the transmitter, thereby enhancing the likelihood of transmitter being quickly located in the dark.

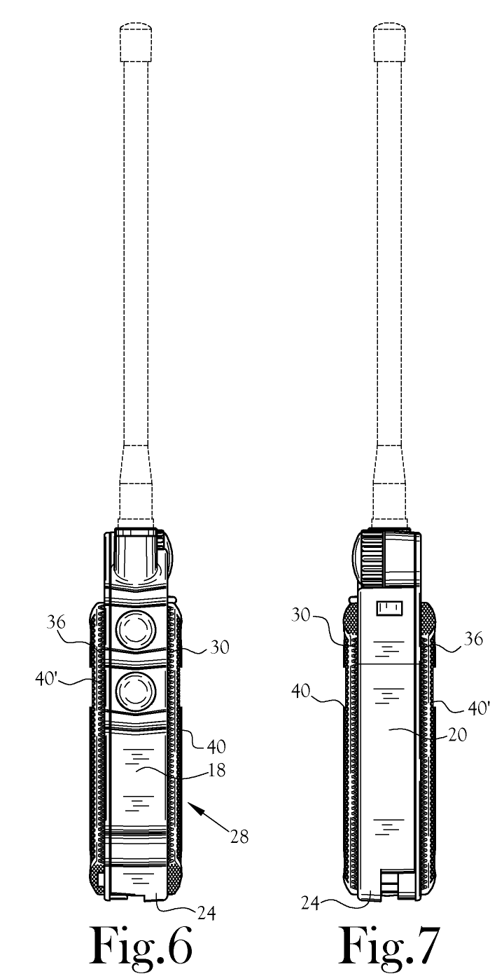

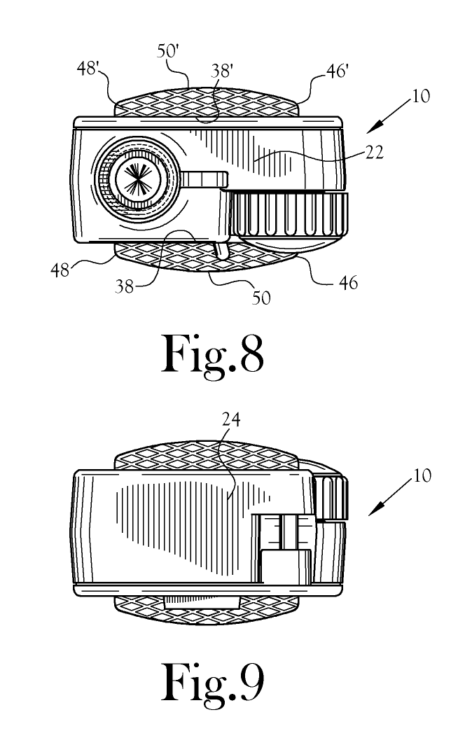

Still further, by reason of the overall geometry of the pistol grip butt of the transmitter, including the relatively broader dimensions of the opposite first and second sides of the transmitter housing, relative to the front and rear sides of the housing, it is most likely that the transmitter having the side panels of the present invention will, if dropped onto the ground, end up with one of the first or second sides of the transmitter housing exposed. Even if the dropped transmitter does not end up with one or its first or second sides exposed, the present invention provides means by which the top, bottom and the outer edges of the first and second sides of a butt grip panel may emit luminescent rays 56 or reflect an applied light beam 58. This feature of the present invention also may be visualized in FIGS. 6 and 7 (edges of first and second butt grip panels) and FIGS. 8 and 9 (top and bottom of first and second butt grip panels) wherein it is noted that both the top and bottom ends of each panel include exposed multifaceted projections which may either emit luminescent rays or reflect an applied light beam.

By reason of the outer surface of each of the first and second side butt grip panels of the present invention exhibiting a curved surface, and the extension of the multifaceted embossments about the edges and top and bottom of each butt grip panel, the top or bottom ends and the edges of either or both of the first and second side panels is exposed beyond the profile of the housing.

Thus, light from those embossments exposed when viewing either the top or bottom end or a side edge of the transmitter leads a user to a dropped transmitter located in a dark environment. By these means there is enhanced exposure of one or both of the panels from a large range of angles of observation. The present invention thus enhances the likelihood that a user, having dropped the transmitter, will be able to detect the luminescence emanating from one or both of the panels, irrespective of the angle of sight from the user to the dropped transmitter. This same effect is achieved in the event the luminescence from the panels is too weak for ready observation and the user must employ a battery-powered source of light to locate the dropped transmitter.

FIGS. 6-9 depict the front 18 and rear 20 sides and the top 22 and bottom 24, respectively, of the transmitter of FIG. 1. From these Figures, the manner in which the curved outer surface of the butt grip panels of the present invention provide enhanced location of a transmitter dropped in a dark environment. From this Figures, it will be noted that even if the transmitter is dropped and only one end or part of one end of the transmitter, or only a portion of one corner of the transmitter, is exposed, a user can, under such circumstances readily detect and retrieve a transmitter which is dropped while in a dark environment.

In one embodiment the grip panels of the present invention are formed from a polycarbonate, such as Lexan 121, which includes a luminescent material that conforms to Glow in the Dark GE Color Code FXL 121R GN7A010L. It will be recognized, given the present disclosure, that other suitable luminescent polymeric materials may be employed in the manufacture of the present grip panels, as well as non-polymeric luminescent materials, without departing from the scope of the present invention.

In one embodiment, the thickness of the butt grip panel is maximum at the longitudinal centerplane 44 of the panel and gradually decreases in thickness laterally away from both the left and right sides of the longitudinal centerplane, to a minimum thickness at each of the side edges of the first and second butt grip panels. In one embodiment, the maximum thickness of a butt grip panel ranges between about 0.20 inch and about 0.25 inch. In this same panel, the minimum thickness of the panel may range between about 0.10 and about 0.15 inch.

Whereas the panels of the present invention preferably include an outwardly curved outer surface, the panels alternatively may be formed with flat outer surfaces, or slightly concave outer surface, but with some potential loss of enhancement of the reflective/refractive nature of the panels. The outer surface of each panel also may be provided with other geometrically shaped depressions and resulting projections, or if desired, the outer surface of each panel may be devoid of such depressions and resulting projections, so long as at least one, and preferably both, of the butt side panels luminesce in a dark environment.

Definition of the multi-faceted embossments of a butt grip panel may be accomplished employing intersecting linear depressions 52 which extend into the grip panel a distance of between about 0.10 inch and about 0.20 inch. In a preferred pyramidal embossments, the multiple faces of these embossments provide the desired multiple facets of each embossment.

What is claimed:

1. A hand-held transmitter useful for the transmission of a signal to a remote receiver comprising
a housing including a pistol butt grip portion, and
having first and second opposed sides, and top and bottom ends,
at least one of said first and second sides defining a surface for the receipt thereon of a butt grip panel,
a butt grip panel including an outwardly exposed surface, mounted on said at least one of said first and second sides of said pistol butt portion of said housing,
said butt grip panel being formed from a luminescent polymeric material.

2. The transmitter of claim 1 and including a butt grip panel mounted on each of said first and second sides of said pistol butt portion of said housing,

3. The transmitter of claim 1 wherein said outwardly exposed surface of said butt grip panel includes a plurality of multifaceted embossments.

4. The transmitter of claim 3 wherein said multifaceted embossments extend about each of said first and second sides and said top and bottom ends of said at least one butt grip panel.

5. The transmitter of claim 4 wherein said multifaceted embossments are defined by a plurality of intersecting spaced-apart lines of indentations into said outer exposed surface of said grip panel.

6. The transmitter of claim 5 wherein said embossments comprise interconnected pyramidal projections extending outwardly of said butt grip panel.

7. The transmitter of claim 1 wherein said luminescent polymeric material comprises a polycarbonate.

8. The transmitter of claim 1 wherein said luminescent polymeric material exhibits a glow in the dark per GE Color Code FXL 121R GN7A010L.

9. The transmitter of claim 1 wherein said at least one butt grip panel includes a longitudinal centerplane and exhibits a curved outer exposed surface having a maximum thickness contiguous said longitudinal centerplane and substantially uniformly decreasing in thickness from said longitudinal centerplane in opposite directions toward said first and second sides of said grip butt panel to a minimum thickness at each of said first and second sides of said butt grip panel

10. The transmitter of claim 9 wherein said maximum thickness ranges between about 0.20 and about 0.25 inch.

11. The transmitter of claim 10 wherein said minimum thickness ranges between about 0.10 and about 0.15 inch.

12. The transmitter of claim 10 wherein each of said lines of indentation in said outwardly exposed surface of said butt grip panel extends inwardly of said butt grip panel a distance of between about 0.10 and about 0.20 inch.
